(19) United States
(12) Patent Application Publication
(10) Pub. No.: US 2020/0334328 A1
(43) Pub. Date: Oct. 22, 2020

(54) INFORMATION PROCESSING DEVICE AND NON-TRANSITORY COMPUTER READABLE MEDIUM

(71) Applicant: FUJI XEROX CO., LTD., Tokyo (JP)

(72) Inventor: Yifan ZHANG, Kanagawa (JP)

(73) Assignee: FUJI XEROX CO., LTD., Tokyo (JP)

(21) Appl. No.: 16/597,934

(22) Filed: Oct. 10, 2019

(30) Foreign Application Priority Data
Apr. 17, 2019 (JP) 2019-078852

(51) Int. Cl. G06F 17/24

(52) U.S. Cl. CPC G06F 17/245; H04N 1/00326; G06F 17/243

(57) ABSTRACT

An information processing device includes a division unit that divides a table in which cells are arranged in rows and columns into multiple sub-tables, and an extraction unit that extracts a value corresponding to a key cell, that is, a cell expressing a key, from each of the multiple sub-tables obtained by the division unit.

### CROSS-REFERENCE TO RELATED APPLICATIONS

This application is based on and claims priority under 35 USC 119 from Japanese Patent Application No. 2019-078852 filed Apr. 17, 2019.

### BACKGROUND

### (i) Technical Field

The present disclosure relates to an information processing device and a non-transitory computer readable medium.

### (ii) Related Art

For example, Japanese Unexamined Patent Application Publication No. 2016-91081 describes a system that imports a format of a form. The system extracts candidate blocks whose attributes match a title registered in a block extraction policy in each block of the form to import, and displays the extracted candidate blocks together with the match rates on a display. The system receives the input of a candidate block selected by a user from among the displayed blocks and match rates, and on the basis of the received candidate block, outputs a definition file based on a block definition in which a template block definition of a definition file of the form to import is created.

### SUMMARY

Meanwhile, for example, in non-standard forms such as receipts, invoices, and purchase orders, the positional relationship between keys and values in a table is not uniform, and associating keys with values may be difficult in some cases. In the case of wanting to extract values for all keys included in a table from such a non-standard form, it may be necessary to predefine the relationships between all keys and values. However, defining relationships for all keys included in a table is not easy.

Aspects of non-limiting embodiments of the present disclosure relate to extracting keys and values corresponding to the keys included in a table, without defining relationships for all keys included in the table.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a division unit that divides a table in which cells are arranged in rows and columns into multiple sub-tables, and an extraction unit that extracts a value corresponding to a key cell that is a cell expressing a key, from each of the multiple sub-tables obtained by the division unit.

### BRIEF DESCRIPTION OF THE DRAWINGS

Exemplary embodiments of the present disclosure will be described in detail based on the following figures, wherein:

FIG. 1 is a block diagram illustrating one example of an electrical configuration of an image forming device according to a first exemplary embodiment;

FIG. 2 is a diagram illustrating one example of a non-standard form according to the exemplary embodiments;

FIG. 3 is a block diagram illustrating one example of a functional configuration of the image forming device according to the first exemplary embodiment;

FIG. 4 is a flowchart illustrating one example of the flow of a process by an extraction processing program according to the first exemplary embodiment;

FIG. 5 is a diagram illustrating one example of an input table according to the exemplary embodiments;

FIG. 6 is a block diagram illustrating one example of a functional configuration of the image forming device according to a second exemplary embodiment;

FIG. 7 is a flowchart illustrating one example of the flow of a process by the extraction processing program according to the second exemplary embodiment;

FIG. 8 is a diagram accompanying a description of a sub-table division method according to the second exemplary embodiment;

FIG. 9 is a block diagram illustrating one example of a functional configuration of the image forming device according to a third exemplary embodiment;

FIG. 10 is a diagram accompanying a description of the sub-table division method according to the third exemplary embodiment;

FIG. 11 is a diagram accompanying a description of a different sub-table division method according to the third exemplary embodiment;

FIG. 12 is a diagram accompanying a description of a different sub-table division method according to the third exemplary embodiment;

FIG. 13 is a block diagram illustrating one example of a functional configuration of the image forming device according to a fourth exemplary embodiment;

FIG. 14 is a flowchart illustrating one example of the flow of a process by the extraction processing program according to the fourth exemplary embodiment; and

FIG. 15 is a diagram accompanying a description of a common key cell determination method according to the fourth exemplary embodiment.

### DETAILED DESCRIPTION

Hereinafter, exemplary embodiments for carrying out the present disclosure will be described in detail and with reference to the drawings.

### First Exemplary Embodiment

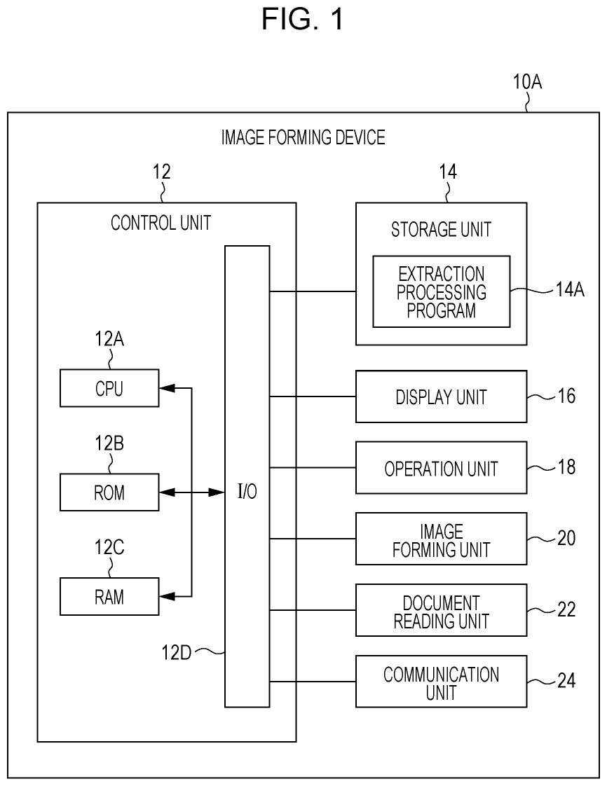

FIG. 1 is a block diagram illustrating one example of an electrical configuration of an image forming device 10A according to the first exemplary embodiment. As illustrated in FIG. 1, the image forming device 10A according to the present exemplary embodiment is provided with a control unit 12, a storage unit 14, a display unit 16, an operation unit 18, an image forming unit 20, a document reading unit 22, and a communication unit 24.

Note that the image forming device 10A is one example of an information processing device. Besides the image forming device 10A, the information processing device may also be applied to devices such as a personal computer (PC), a smartphone, or a tablet, for example.

The control unit 12 is provided with a central processing unit (CPU) 12A, read-only memory (ROM) 12B, random access memory (RAM) 12C, and an input/output interface (I/O) 12D. These components are interconnected via a bus.

Each functional unit, including the storage unit 14, the display unit 16, the operation unit 18, the image forming unit 20, the document reading unit 22, and the communication unit 24, is connected to the I/O 12D. Each of these functional units is capable of bidirectional communication with the CPU 12A via the I/O 12D.

The control unit 12 may be configured as a sub-controller that controls a subset of operations of the image forming device 10A, or may be configured as a main controller that controls all operations of the image forming device 10A. An integrated circuit such as a large-scale integration (LSI) chip or an integrated circuit (IC) chipset, for example, is used for some or all of the blocks of the control unit 12. A discrete circuit may be used for each of the above blocks, or a circuit integrating some or all of the above blocks may be used. The above blocks may be provided together as a single body, or some blocks may be provided separately. Also, a part of each of the above blocks may be provided separately. The integration of the control unit 12 is not limited to LSI, and a dedicated circuit or a general-purpose processor may also be used.

For the storage unit 14, a hard disk drive (HDD), a solid-state drive (SSD), flash memory, or the like is used, for example. The storage unit 14 stores an extraction processing program 14A for realizing a function of extracting table data according to the present exemplary embodiment. Note that the extraction processing program 14A may also be stored in the ROM 12B.

The extraction processing program 14A may be preinstalled in the image forming device 10A, for example. The extraction processing program 14A may also be realized by being stored on a non-volatile storage medium or distributed over a network, and appropriately installed in the image forming device 10A. Note that anticipated examples of the non-volatile storage medium include a Compact Disc-Read-Only Memory (CD-ROM), a magneto-optical disc, an HDD, a Digital Versatile Disc-Read-Only Memory (DVD-ROM), flash memory, a memory card, and the like.

For the display unit 16, for example, a liquid crystal display (LCD), an organic electroluminescence (EL) display, or the like is used. The display unit 16 includes an integrated touch panel. On the operation unit 18, various operation keys such as a keypad and a Start key are provided. The display unit 16 and the operation unit 18 accept various instructions from a user of the image forming device 10A. The various instructions include, for example, an instruction to start reading a document, an instruction to start copying a document, and the like. The display unit 16 displays various information such as the results of processes executed in accordance with instructions received from the user, notifications about processes, and the like.

The document reading unit 22 takes in one page at a time of a document placed on a paper feed tray of an automatic document feeder (not illustrated) provided on the top of the image forming device 10A, and optically reads the taken-in document to obtain image information. Alternatively, the document reading unit 22 optically reads a document placed on a document bed such as a platen glass to obtain image information.

The image forming unit 20 forms, on a recording medium such as paper, an image based on image information obtained by the reading by the document reading unit 22, or image information obtained from an external PC or the like connected via a network. Note that although the present exemplary embodiment is described by taking an electrophotographic system as an example of the system of forming images, but another system, such as an inkjet system, may also be adopted.

In the case in which the system of forming images is an electrophotographic system, the image forming unit 20 includes a photoreceptor drum, a charger, an exposure unit, a developer, a transfer unit, and a fuser. The charger applies a voltage to the photoreceptor drum to charge the surface of the photoreceptor drum. The exposure unit forms an electrostatic latent image on the photoreceptor drum by exposing the photoreceptor drum charged by the charger with light corresponding to the image information. The developer forms a toner image on the photoreceptor drum by developing with toner the electrostatic latent image formed on the photoreceptor drum. The transfer unit transfers the toner image formed on the photoreceptor drum onto a recording medium. The fuser fuses the transferred toner image to the recording medium with heat and pressure.

The communication unit 24 is connected to a network such as the Internet, a local area network (LAN), or a wide area network (WAN), and is capable of communicating with an external PC and the like over the network.

The image forming device 10A according to the present exemplary embodiment is provided with an optical character recognition (OCR) function, and is capable of converting an image included in image information into one or more character codes by performing character recognition.

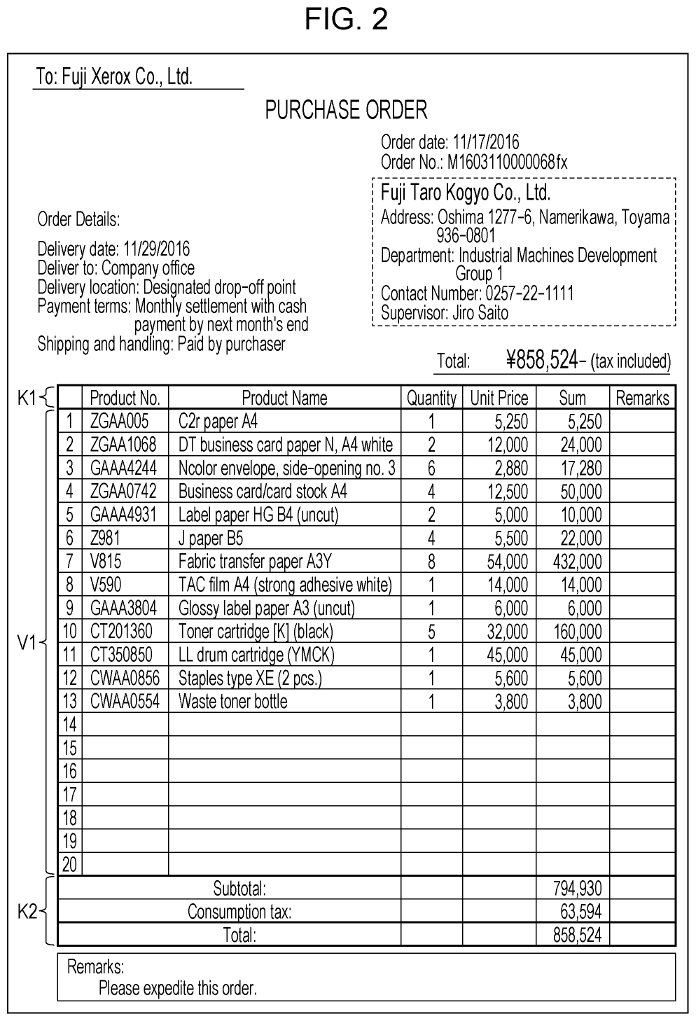

Meanwhile, in a non-standard form like the one illustrated in FIG. 2 for example, the positional relationship between keys and values in a table is not uniform, and associating keys with values may be difficult in some cases.

FIG. 2 is a diagram illustrating one example of a non-standard form according to the present exemplary embodiment. The non-standard form illustrated in FIG. 2 includes a key portion K1, a value portion V1, and a key portion K2.

Herein, a key in a table refers to an item that the user wants to extract from among multiple items included in the table, and is expressed as a character string for example. Each character string contains one or more letters, and may also contain numerals, symbols, and the like. Also, a value in a table refers to a value that corresponds to a key. In the case of the example in FIG. 2, the key portion K1 includes “Product No.”, “Product Name”, “Quantity”, “Unit Price”, “Sum”, and “Remarks” as multiple keys. Also, the value portion V1 includes values corresponding to each key in the key portion K1. Also, the key portion K2 includes “Subtotal:”, “Consumption tax:”, and “Total:” as multiple keys, and additionally includes values corresponding to each of these multiple keys.

In the case of wanting to extract the values for all keys included in the table from the non-standard form illustrated in FIG. 2, it may be necessary to predefine the relationships between all keys and values, but defining relationships for all keys included in a table is not easy.

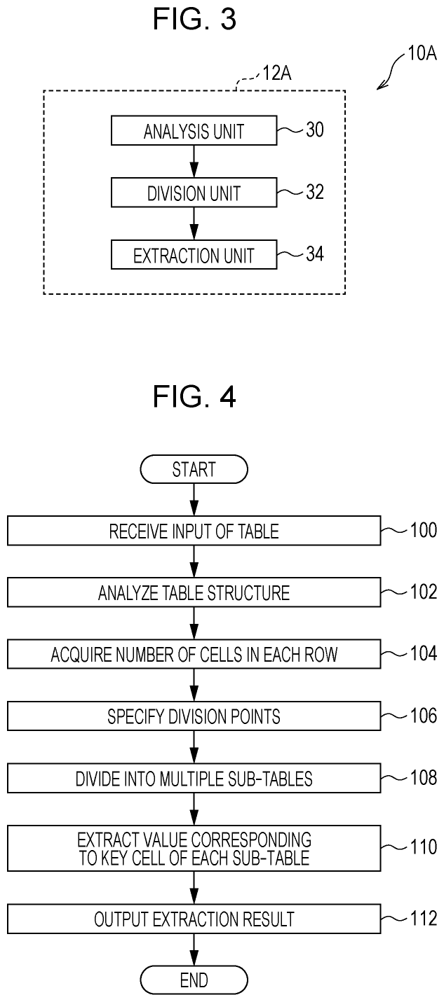

For this reason, by loading the extraction processing program 14A stored in the storage unit 14 into the RAM 12C and executing the extraction processing program 14A, the CPU 12A of the image forming device 10A according to the present exemplary embodiment functions as each component illustrated in FIG. 3.

FIG. 3 is a block diagram illustrating one example of a functional configuration of the image forming device 10A according to the first exemplary embodiment. As illustrated in FIG. 3, the CPU 12A of the image forming device 10A according to the present exemplary embodiment functions as an analysis unit 30, a division unit 32, and an extraction unit 34.

The analysis unit 30 according to the present exemplary embodiment acquires a table input as a result of reading by the document reading unit 22 or a table input from an external PC or the like, and performs table structure analysis on the acquired table. Note that the table to be processed in the present exemplary embodiment is a table in which cells are arranged in rows and columns, and which may or may not have gridlines. In the table structure analysis, table structure information, such as the number of table rows, the number of table columns, and the table layout, is acquired. Publicly known techniques are applied to the table structure analysis. Note that in the case in which the table is electronic data and table structure information is included in the electronic data, the table structure information may be acquired from the electronic data.

The division unit 32 according to the present exemplary embodiment divides the table subjected to table structure analysis by the analysis unit 30 into multiple sub-tables. A sub-table is defined as one portion of a single table obtained by dividing the table. Specifically, the division unit 32 specifies division points of the table rows or columns on the basis of the number of cells in each row or column of the table, and divides the table into multiple sub-tables according to the specified division points. As an example, a division point is specified as a row or a column where the number of cells changes.

The extraction unit 34 according to the present exemplary embodiment extracts values corresponding to key cells from each of the multiple sub-tables obtained by the division unit 32. Note that a key cell is a cell expressing a key, and all key cells are included in a header range of the table. A header range is a range expressing header rows and header columns in the table. The header range may contain not only key cells that the user wants to extract, but also character strings expressing simple items.

Next, FIG. 4 will be referenced to describe the action of the image forming device 10A according to the first exemplary embodiment.

FIG. 4 is a flowchart illustrating one example of the flow of a process by the extraction processing program 14A according to the first exemplary embodiment.

First, if the image forming device 10A is instructed to launch the extraction processing program 14A, each of the following steps is executed. Hereinafter, a case of dividing a table into sub-tables in the row direction will be described, but the same also applies to the case of dividing a table into sub-tables in the column direction. Note that the direction (horizontal direction) of collinear rows is designated the row direction, while the direction (vertical direction) of collinear columns is designated the column direction.

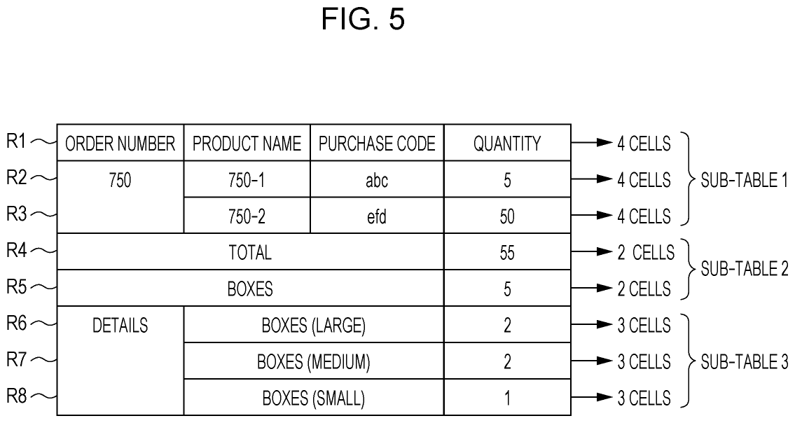

In step 100 of FIG. 4, the analysis unit 30 receives the input of the table illustrated in FIG. 5, for example.

FIG. 5 is a diagram illustrating one example of an input table according to the present exemplary embodiment. The input table illustrated in FIG. 5 is a table that includes multiple rows R1 to R8, in which cells are arranged in rows and columns.

In step 102, the analysis unit 30 performs table structure analysis on the input table received in step 100, and acquires table structure information including information such as the number of table rows, the number of table columns, and the table layout. In the case of the example in FIG. 5, a table having eight rows (row numbers 1 to 8 are omitted from illustration) and four columns (column numbers 1 to 4 are omitted from illustration) is analyzed. On each of the rows R1 to R3, four cells are arranged in the row direction. On each of the rows R4 and R5, two cells are arranged in the row direction. On each of the rows R6 to R8, three cells are arranged in the row direction. A single cells is expressed using a row number (R) and a column number (C). For example, the “Order Number” cell is expressed as R1C1. Also, a merged cell created by merging two or more cells includes the row number and column number information from before the merge. For example, the “Total” cell is a merged cell, but includes the information R4C1, R4C2, and R4C3. For this reason, the “Total” cell is expressed as at least one cell from among R4C1, R4C2, and R4C3.

In step 104, the division unit 32 uses the table structure information acquired in step 102 to acquire the number of cells in each row of the input table. In the example of FIG. 5, there are four cells in each of the rows R1 to R3, two cells in each of the rows R4 and R5, and three cells in each of the rows R6 to R8.

In step 106, the division unit 32 specifies division points on the basis of the number of cells in each row acquired in step 104. The division points according to the present exemplary embodiment are specified as rows where the number of cells changes. In the example of FIG. 5, the number of cells changes to 2 in the row R4, and the number of cells changes to 3 in the row R6. For this reason, the rows R4 and R6 are specified as the division points.

In step 108, the division unit 32 divides the input table received in step 100 into multiple sub-tables according to the division points specified in step 106. Specifically, in the example of FIG. 5, each of the rows R4 and R6 is treated as a division point to divide the input table into a sub-table 1 including the rows R1 to R3, a sub-table 2 including the rows R4 and R5, and a sub-table 3 including the rows R6 to R8.

In step 110, the extraction unit 34 extracts values corresponding to key cells from each of the multiple sub-tables divided in step 108. Specifically, a header range is specified for each of the multiple sub-tables, cells outside the specified header range are treated as values, and the values corresponding to key cells included in the header range are extracted. The method of specifying the header range is not particularly limited, but may be specified by the user, specified by using differences in the appearance of the cells, or specified according to the presence or absence of a diagonal line inside the cells, for example. Note that differences in the appearance of the cells may include differences in the cell background (such as color or hatching), textual differences (such as the font, size, color, and boldface), and border differences, for example.

In step 112, the extraction unit 34 outputs the results extracted in step 110 to the storage unit 14 for example, and ends the series of processes by the extraction processing program 14A.

In this way, according to the present exemplary embodiment, an input table is divided into multiple sub-tables using the number of cells in rows or columns, and for each sub-table, keys included in the input table and values corresponding to the keys are extracted. For this reason, it is no longer necessary to define relationships for all keys included in the input table.

### Second Exemplary Embodiment

The first exemplary embodiment above describes an arrangement in which an input table is divided into multiple sub-tables using the number of cells in rows or columns. The present exemplary embodiment describes an arrangement in which an input table is divided into multiple sub-tables using rows or columns that include key cells specified by the user.

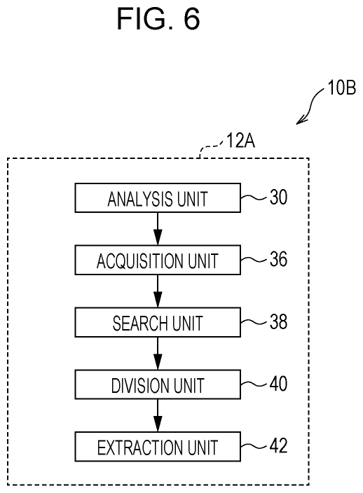

FIG. 6 is a block diagram illustrating an example of a functional configuration of an image forming device 10B according to the second exemplary embodiment. Note that component elements having a similar function as the image forming device 10A according to the first exemplary embodiment above will be denoted with the same signs, and a repeated description will be omitted.

As illustrated in FIG. 6, the CPU 12A of the image forming device 10B according to the present exemplary embodiment functions as the analysis unit 30, an acquisition unit 36, a search unit 38, a division unit 40, and an extraction unit 42.

The acquisition unit 36 according to the present exemplary embodiment acquires the contents of cells included in a table subjected to table structure analysis by the analysis unit 30. Specifically, the acquisition unit 36 acquires character strings inside the cells. For example, in the case in which the table is input as image data through reading by the document reading unit 22, a character recognition process is performed on the image data, and a character string is acquired for each cell. On the other hand, in the case in which the table is input as electronic data in a predetermined data format from an external PC or the like, the electronic data may be analyzed to acquire a character string for each cell.

The search unit 38 according to the present exemplary embodiment searches the table whose cell contents have been acquired by the acquisition unit 36 for multiple key cells including a character string that matches at least a portion of a character string input as a key by the user.

The division unit 40 according to the present exemplary embodiment specifies division points of the table rows or columns on the basis of the multiple key cells retrieved by the search unit 38, and divides the table into multiple sub-tables according to the specified division points. As an example, a division point is specified as a row or a column that includes each of multiple key cells.

The extraction unit 42 according to the present exemplary embodiment extracts values corresponding to key cells from each of the multiple sub-tables obtained by the division unit 40.

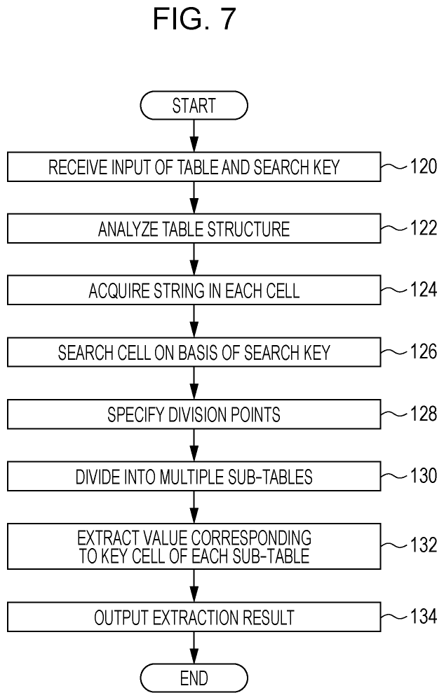

Next, FIG. 7 will be referenced to describe the action of the image forming device 10B according to the second exemplary embodiment.

FIG. 7 is a flowchart illustrating one example of the flow of a process by the extraction processing program 14A according to the second exemplary embodiment.

First, if the image forming device 10B is instructed to launch the extraction processing program 14A, each of the following steps is executed. Hereinafter, a case of dividing a table into sub-tables in the row direction will be described, but the same also applies to the case of dividing a table into sub-tables in the column direction.

In step 120 of FIG. 7, the analysis unit 30 receives the input of the table illustrated in FIG. 5 described above, for example. Also, the search unit 38 receives the input of a character string to act as a search key from the user, in correspondence with the received input table.

In step 122, the analysis unit 30 performs table structure analysis on the input table received in step 120, and acquires table structure information including information such as the number of table rows, the number of table columns, and the table layout.

In step 124, the acquisition unit 36 uses the table structure information acquired in step 122 to acquire the character string in each cell included in the input table received in step 120.

In step 126, the search unit 38 searches for multiple cells in the input table received in step 120 on the basis of the search key input in step 120. Specifically, the character string in each cell acquired in step 124 is compared to the character string input as the search key in step 120, and multiple cells including a character string that matches at least a portion of the character string acting as the search key are retrieved.

In step 128, the division unit 40 specifies division points on the basis of the multiple cells (that is, key cells) retrieved in step 126. Specifically, rows including each of multiple key cells are specified as division points.

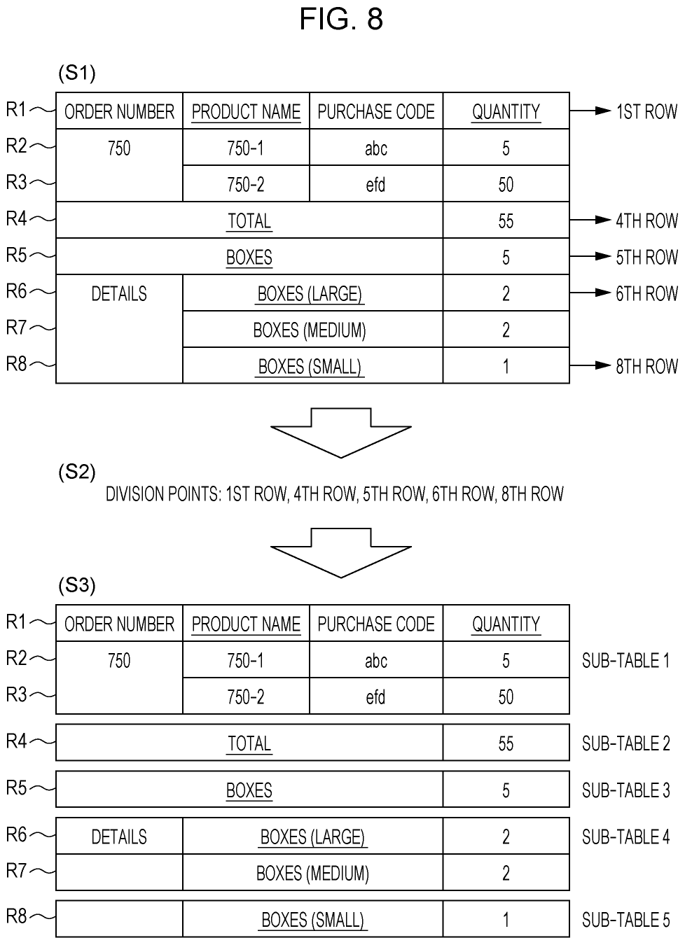

In step 130, the division unit 40 divides the input table received in step 120 into multiple sub-tables according to the division points specified in step 128. Herein, FIG. 8 will be referenced to specifically describe the sub-table division method according to the second exemplary embodiment.

FIG. 8 is a diagram accompanying the description of the sub-table division method according to the second exemplary embodiment. The input table illustrated in FIG. 8 includes multiple rows R1 to R8, similarly to the input table illustrated in FIG. 5 described above.

In (S1), as described above, multiple cells are retrieved from the input table on the basis of a search key. In the example of FIG. 8, to more easily identity the retrieved character strings, the character strings in key cells that match the character string of the search key input by the user are underlined. Herein, as an example, “Product Name”, “Quantity”, “Total”, “Boxes”, “Boxes (large)”, and “Boxes (small)” have been retrieved as key cells.

In (S2), division points are specified on the basis of the above retrieved key cells. Specifically, rows including each of the multiple retrieved key cells are specified as division points. Herein, as one example, the row R1 including “Product Name” and “Quantity”, the row R4 including “Total”, the row R5 including “Boxes”, the row R6 including “Boxes (large)”, and the row R8 including “Boxes (small)” are specified as division points.

In (S3), the input table is divided into multiple sub-tables according to the division points specified above. Specifically, the one or more rows from a row specified as a division point to the row immediately preceding the row specified as the next division point are obtained by division as a single sub-table. Herein, as one example, the input table is divided such that the rows R1 to R3 become a sub-table 1, the row R4 becomes a sub-table 2, the row R5 becomes a sub-table 3, the rows R6 and R7 become a sub-table 4, and the row R8 becomes a sub-table 5.

Returning to FIG. 7, in step 132, the extraction unit 42 extracts values corresponding to key cells from each of the multiple sub-tables divided in step 130. Specifically, as described above, a header range is specified for each of the multiple sub-tables, cells outside the specified header range are treated as values, and the values corresponding to key cells included in the header range are extracted.

In step 134, the extraction unit 42 outputs the results extracted in step 132 to the storage unit 14 for example, and ends the series of processes by the extraction processing program 14A.

In this way, according to the present exemplary embodiment, an input table is divided into multiple sub-tables using the rows or columns including key cells specified by the user, and for each sub-table, keys included in the input table and values corresponding to the keys are extracted. For this reason, it is no longer necessary to define relationships for all keys included in the input table.

### Third Exemplary Embodiment

The present exemplary embodiment describes an arrangement that, in the case of dividing a table into multiple sub-tables, suppresses over-division into an unnecessarily large number of sub-tables.

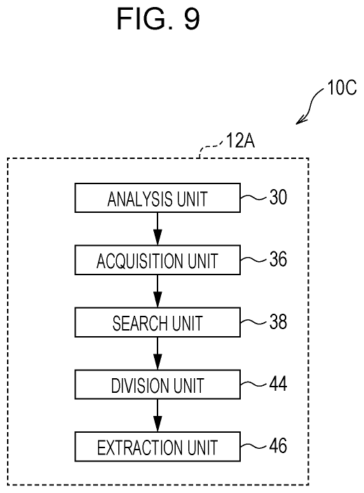

FIG. 9 is a block diagram illustrating an example of a functional configuration of an image forming device 10C according to the third exemplary embodiment. Note that component elements having a similar function as the image forming device 10B according to the second exemplary embodiment above will be denoted with the same signs, and a repeated description will be omitted.

As illustrated in FIG. 9, the CPU 12A of the image forming device 10C according to the present exemplary embodiment functions as the analysis unit 30, the acquisition unit 36, the search unit 38, a division unit 44, and an extraction unit 46.

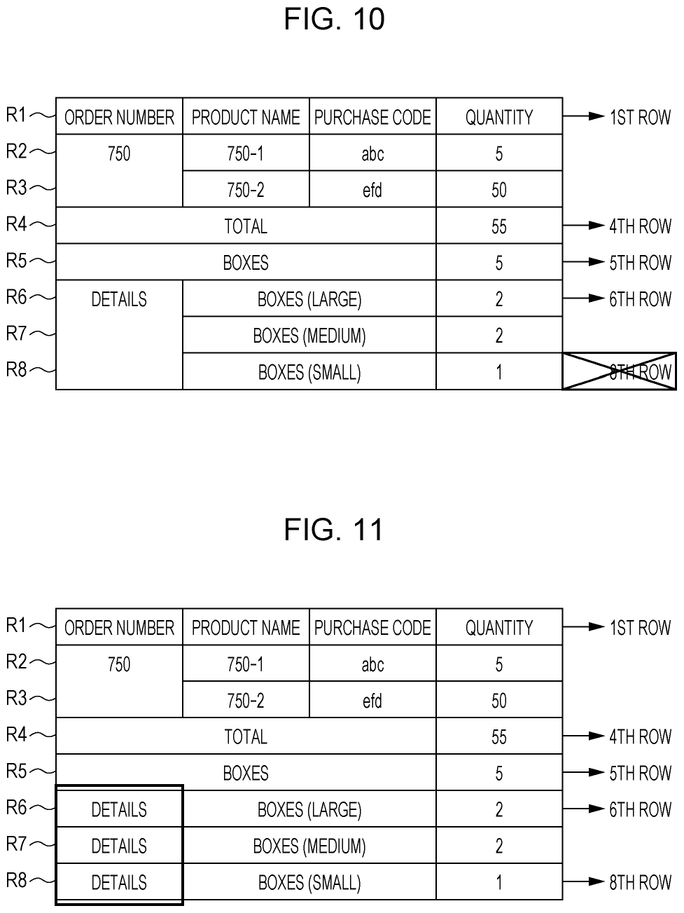

In a case in which a portion of a merged cell created by merging two or more cells is included in a row or a column including a key cell retrieved by the search unit 38, the division unit 44 according to the present exemplary embodiment does not specify the row or column including the portion of the merged cell as a division point. This behavior will be specifically described with reference to FIG. 10.

FIG. 10 is a diagram accompanying the description of the sub-table division method according to the third exemplary embodiment. The input table illustrated in FIG. 10 includes multiple rows R1 to R8, similarly to the input table illustrated in FIG. 5 described above.

In the second exemplary embodiment above, because “Boxes (small)” is a key cell, the row R8 is obtained by division as a sub-table, but the row R8 includes a cell that is part of the merged cell “Details”. In this case, if the row R8 is obtained by division as a sub-table, because the cell that is part of the merged cell is blank (empty), in some cases it may be difficult to determine that the cell that is part of the merged cell is “Details”. Consequently, in such cases, the row R8 is not specified as a division point. In other words, in the example of FIG. 10, the row R8 is not obtained by division as a single sub-table, and instead the rows R6 to R8 are obtained by division as a single sub-table.

Also, in a case in which a portion of a merged cell created by merging two or more cells is included in a row or a column including a key cell retrieved by the search unit 38, the division unit 44 according to the present exemplary embodiment may copy the character string of the merged cell into each cell of the merged cell. This behavior will be specifically described with reference to FIG. 11.

FIG. 11 is a diagram accompanying a description of a different sub-table division method according to the third exemplary embodiment. The input table illustrated in FIG. 11 includes multiple rows R1 to R8, similarly to the input table illustrated in FIG. 5 described above.

In the example of FIG. 10 described above, each of the rows R8 and R7 includes a cell that is part of the merged cell “Details” (these cells are referred to as “blank cells”). In contrast, in the example of FIG. 11, the character string of the merged cell (herein, “Details”) is copied into each blank cell. In other words, the character string of the merged cell included in the row R6 is copied into the respective blank cells in the rows R8 and R7. For this reason, even if the row R8 is obtained by division as a sub-table, the cell that is part of the merged cell included in the row R8 is easily determined to be “Details”.

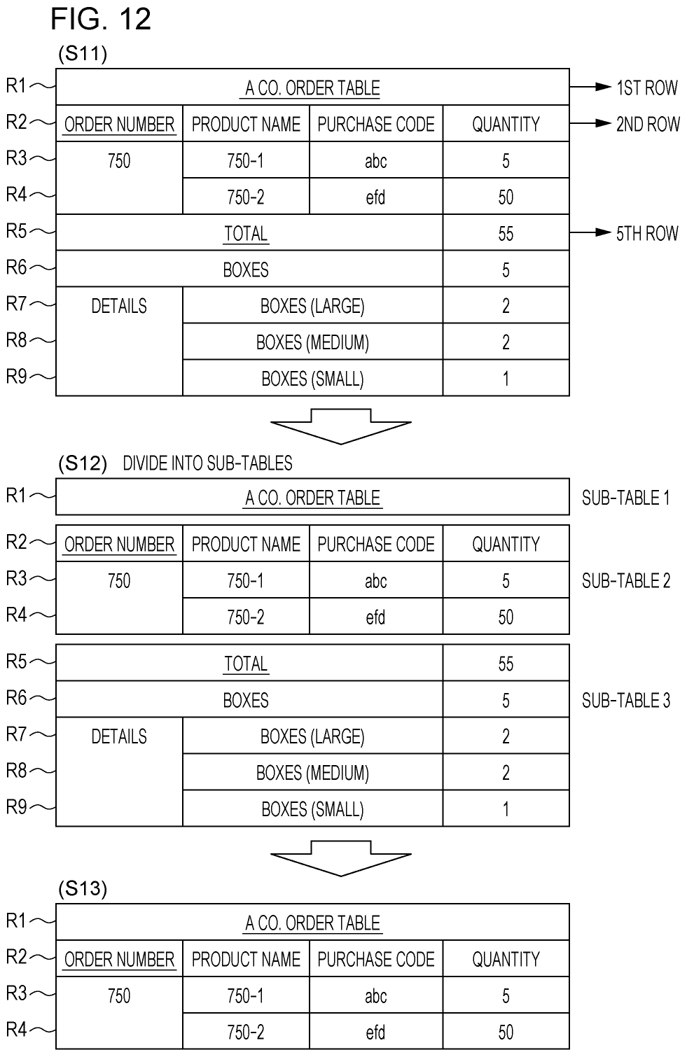

Also, in a case in which a sub-table does not include a value cell corresponding to a key cell included in the sub-table, the division unit 44 may combine the sub-table with another sub-table adjacent to the sub-table. Note that a value cell refers to a cell expressing a value corresponding to a key cell. This behavior will be specifically described with reference to FIG. 12.

FIG. 12 is a diagram accompanying a description of a different sub-table division method according to the third exemplary embodiment. The input table illustrated in FIG. 12 includes multiple rows R1 to R9.

In (S11), as described above, multiple cells are retrieved from the input table on the basis of a search key. In the example of FIG. 12, to more easily identity the retrieved character strings, the character strings in key cells that match the character string of the search key input by the user are underlined. Herein, as an example, “A Co. Order Table”, “Order Number”, and “Total” have been retrieved as key cells.

In (S12), division points are specified on the basis of the above retrieved key cells. Specifically, rows including each of the multiple retrieved key cells are specified as division points. Herein, as an example, the row R1 including “A Co. Order Table”, the row R2 including “Order Number”, and the row R5 including “Total” have been retrieved as key cells. Subsequently, the input table is divided into multiple sub-tables according to the specified division points. Specifically, as described above, the one or more rows from a row specified as a division point to the row immediately preceding the row specified as the next division point are obtained by division as a single sub-table. Herein, as one example, the input table is divided such that the row R1 becomes a sub-table 1, the rows R2 to R4 become a sub-table 2, and the rows R5 to R9 becomes a sub-table 3.

In (S13), the sub-table 1 obtained by the above division and another sub-table adjacent to the sub-table 1, namely the sub-table 2, are combined. The sub-table 1 does not include a value cell corresponding to a key cell (herein, “A Co. Order Table”). Because the sub-table 1 that does not include a value cell lacks a value cell to extract if divided alone, in such cases, the sub-table 1 is combined with the sub-table 2 positioned below the sub-table 1. In other words, the row R1 is unified with the rows R2 to R4, and the rows R1 to R4 are obtained as a single sub-table.

The extraction unit 46 according to the present exemplary embodiment extracts values corresponding to key cells from each of the multiple sub-tables obtained by the division unit 44. Specifically, as described above, a header range is specified for each of the multiple sub-tables, cells outside the specified header range are treated as values, and the values corresponding to key cells included in the header range are extracted.

In this way, according to the present exemplary embodiment, in the case of dividing an input table into multiple sub-tables, over-division into an unnecessarily large number of sub-tables is suppressed. Note that although the present exemplary embodiment illustrates a case of specifying the division points on the basis of a search key input by the user, the present exemplary embodiment is also similarly applicable to the case of specifying the division points using changes in the numbers of cells in the rows or columns.

### Fourth Exemplary Embodiment

The present exemplary embodiment describes an arrangement that extracts a key cell shared in common by value cells in one sub-table and another sub-table adjacent to the sub-table.

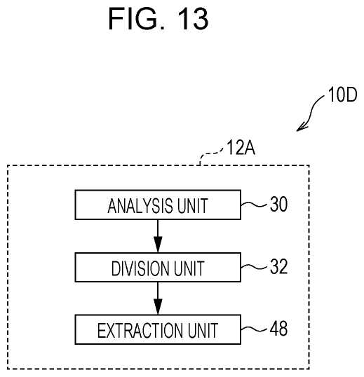

FIG. 13 is a block diagram illustrating one example of a functional configuration of a image forming device 10D according to the fourth exemplary embodiment. Note that component elements having a similar function as the image forming device 10A according to the first exemplary embodiment above will be denoted with the same signs, and a repeated description will be omitted.

As illustrated in FIG. 13, the CPU 12A of the image forming device 10D according to the present exemplary embodiment functions as an analysis unit 30, a division unit 32, and an extraction unit 48.

The extraction unit 48 according to the present exemplary embodiment extracts a key cell (hereinafter referred to as a “common key cell”) shared in common by value cells between one sub-table and another sub-table adjacent to the sub-table from among the multiple sub-tables obtained by the division unit 32. Specifically, the key cell included in the other sub-table is positioned in the same row or column as the row or column that includes the value cell of the sub-table.

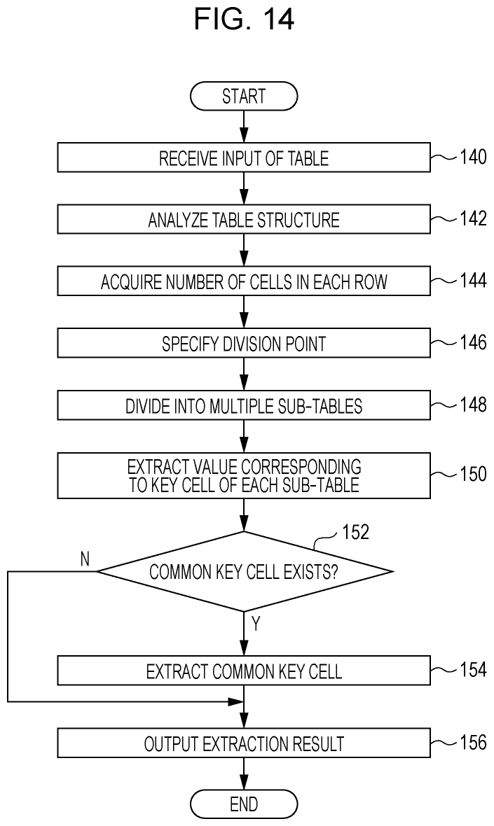

Next, FIG. 14 will be referenced to describe the action of the image forming device 10D according to the fourth exemplary embodiment.

FIG. 14 is a flowchart illustrating one example of the flow of a process by the extraction processing program 14A according to the fourth exemplary embodiment.

First, if the image forming device 10D is instructed to launch the extraction processing program 14A, each of the following steps is executed. Hereinafter, a case of dividing a table into sub-tables in the row direction will be described, but the same also applies to the case of dividing a table into sub-tables in the column direction.

In step 140 of FIG. 14, the analysis unit 30 receives the input of the table illustrated in FIG. 5, for example.

In step 142, the analysis unit 30 performs table structure analysis on the input table received in step 140, and acquires table structure information including information such as the number of table rows, the number of table columns, and the table layout.

In step 144, the division unit 32 uses the table structure information acquired in step 142 to acquire the number of cells in each row of the input table. In the example of FIG. 5, there are four cells in each of the rows R1 to R3, two cells in each of the rows R4 and R5, and three cells in each of the rows R6 to R8.

In step 146, the division unit 32 specifies division points on the basis of the number of cells in each row acquired in step 144. The division points according to the present exemplary embodiment are specified as rows where the number of cells changes. In the example of FIG. 5, the number of cells changes to 2 in the row R4, and the number of cells changes to 3 in the row R6. For this reason, the rows R4 and R6 are specified as the division points.

In step 148, the division unit 32 divides the input table received in step 140 into multiple sub-tables according to the division points specified in step 146. Specifically, in the example of FIG. 5, each of the rows R4 and R6 is treated as a division point to divide the input table into a sub-table 1 including the rows R1 to R3, a sub-table 2 including the rows R4 and R5, and a sub-table 3 including the rows R6 to R8.

In step 150, the extraction unit 48 extracts values corresponding to key cells from each of the multiple sub-tables divided in step 148. Specifically, as described above, a header range is specified for each of the multiple sub-tables, cells outside the specified header range are treated as values, and the values corresponding to key cells included in the header range are extracted.

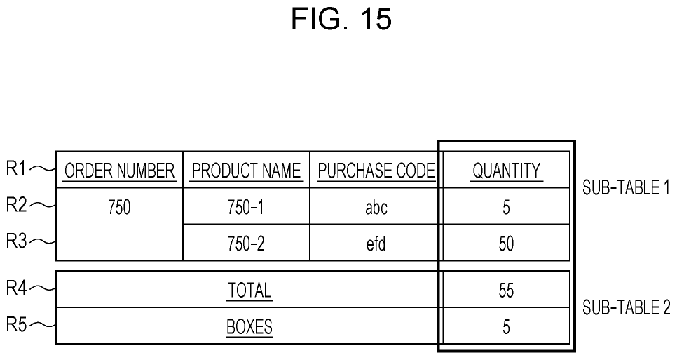

In step 152, on the basis of the results extracted in step 150, the extraction unit 48 determines whether or not a common key cell exists between one sub-table and another sub-table adjacent to the sub-table. In the case of determining that a common key cell exists between the sub-tables (the case of a positive determination), the flow proceeds to step 154, whereas in the case of determining that a common key cell does not exist between the sub-tables (the case of a negative determination), the flow proceeds to step 156. Herein, FIG. 15 will be referenced to specifically describe the common key cell determination method according to the fourth exemplary embodiment.

FIG. 15 is a diagram accompanying a description of a common key cell determination method according to the fourth exemplary embodiment. Similarly to the input table illustrated in FIG. 5 described above, the input table illustrated in FIG. 15 includes multiple rows R1 to R8, but herein, only the rows R1 to R5 are illustrated while the rows R6 to R8 are omitted from illustration.

In the example of FIG. 15, to more easily identify key cells, the character strings of the key cells are underlined. Herein, as an example, “Order Number”, “Product Name”, “Purchase Code”, “Quantity”, “Total”, and “Boxes” are treated as key cells.

As illustrated in FIG. 15, a sub-table 1 including the rows R1 to R3 and a sub-table 2 including the rows R4 and R5 are acquired. The key cell “Quantity” included in the sub-table 1 is positioned in the same column as the column including the value cell “55” and the value cell “5” in the sub-table 2. Note that, as described above, a merged cell created by merging two or more cells includes the row number and column number information from before the merge. In the sub-table 1 illustrated in FIG. 15, the key cell “Quantity” includes information indicating the fourth column. Also, in the sub-table 2, the key cell “Total” is a merged cell and therefore includes information indicating the first to third columns, while the value cell “55” includes information indicating the fourth column. Similarly, the key cell “Boxes” is a merged cell and therefore includes information indicating the first to third columns, while the value cell “5” includes information indicating the fourth column. In this case, the value cell “55” and the value cell “5” are determined to be shared in common between the sub-table 1 and the sub-table 2. For this reason, the key cell “Quantity” in the sub-table 1 is determined to be a common key cell shared with the sub-table 2.

Returning to FIG. 14, in step 154, the extraction unit 48 extracts the common key cell from the other sub-table. In the example of FIG. 15, the key cell “Quantity” in the sub-table 1 is treated as a common key cell shared with the sub-table 2.

In step 156, the extraction unit 34 outputs the results extracted in step 150 or step 154 to the storage unit 14 for example, and ends the series of processes by the extraction processing program 14A.

In this way, according to the present exemplary embodiment, a key cell shared in common by value cells between sub-tables is extracted from another sub-table adjacent to a sub-table. For this reason, even if the input table is divided into multiple sub-tables, the relationships between the sub-tables are not lost. Note that although the present exemplary embodiment illustrates a case of specifying the division points using changes in the numbers of cells in the rows or columns, the present exemplary embodiment is also similarly applicable to the case of specifying the division points on the basis of a search key input by the user.

The above description takes an image forming device as one example of the information processing device according to the exemplary embodiments. An exemplary embodiment may also be configured as a program that causes a computer to execute the functions of each component provided in the image forming device. An exemplary embodiment may also be configured as a computer-readable storage medium storing the program.

Otherwise, the configuration of the image forming device described in the exemplary embodiments above is an example, and may be modified according to circumstances within a scope that does not depart from the gist.

Also, the process flows of the program described in the exemplary embodiments above are an example, and unnecessary steps may be removed, new steps may be added, or the processing sequence may be rearranged within a range that does not depart from the gist.

Also, the exemplary embodiments above describe a case in which the processes according to the exemplary embodiments are realized by a software configuration using a computer by executing a program, but the configuration is not limited thereto. An exemplary embodiment may also be realized by a hardware configuration, or by a combination of a hardware configuration and a software configuration, for example.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a division unit that divides a table in which cells are arranged in rows and columns into a plurality of sub-tables; and
an extraction unit that extracts a value corresponding to a key cell that is a cell expressing a key, from each of the plurality of sub-tables obtained by the division unit.

2. The information processing device according to claim 1, wherein
the division unit divides the table into the plurality of sub-tables according to one or more division points of the rows or columns of the table, the division points being specified on a basis of a number of cells in each row or column of the table.

3. The information processing device according to claim 2, wherein
each division point is specified as a row or a column where the number of cells changes.

4. The information processing device according to claim 1, further comprising:
a search unit that searches the table for a plurality of key cells including a character string that matches at least a portion of a character string input as a key by a user, wherein
the division unit divides the table into the plurality of sub-tables according to one or more division points of the rows or columns of the table, the division points being specified on a basis of the plurality of key cells retrieved by the search unit.

5. The information processing device according to claim 4, wherein
each division point is specified as a row or a column that includes each of the plurality of key cells.

6. The information processing device according to claim 4, wherein
in a case in which a portion of a merged cell created by merging two or more cells is included in a row or a column including a key cell retrieved by the search unit, the division unit does not specify the row or column including the portion of the merged cell as a division point.

7. The information processing device according to claim 5, wherein
in a case in which a portion of a merged cell created by merging two or more cells is included in a row or a column including a key cell retrieved by the search unit, the division unit does not specify the row or column including the portion of the merged cell as a division point.

8. The information processing device according to claim 4, wherein
in a case in which a portion of a merged cell created by merging two or more cells is included in a row or a column including a key cell retrieved by the search unit, the division unit copies a character string of the merged cell into each cell of the merged cell.

9. The information processing device according to claim 5, wherein
in a case in which a portion of a merged cell created by merging two or more cells is included in a row or a column including a key cell retrieved by the search unit, the division unit copies a character string of the merged cell into each cell of the merged cell.

10. The information processing device according to claim 4, wherein
in a case in which a sub-table does not include a value cell, that is, a cell expressing a value, corresponding to a key cell included in the sub-table, the division unit combines the sub-table with another sub-table adjacent to the sub-table.

11. The information processing device according to claim 5, wherein
in a case in which a sub-table does not include a value cell, that is, a cell expressing a value, corresponding to a key cell included in the sub-table, the division unit combines the sub-table with another sub-table adjacent to the sub-table.

12. The information processing device according to claim 1, wherein
the extraction unit extracts a key cell shared in common by value cells that are cells expressing a value, between one sub-table and another sub-table adjacent to the sub-table from the other sub-table.

13. The information processing device according to claim 12, wherein
the key cell included in the other sub-table is positioned in a same row or column as a row or column that includes the value cell of the sub-table.

14. A non-transitory computer readable medium storing a program causing a computer to execute a process for processing information, the process comprising:
dividing a table in which cells are arranged in rows and columns into a plurality of sub-tables; and
extracting a value corresponding to a key cell that is a cell expressing a key, from each of the plurality of sub-tables obtained by the dividing.

15. An information processing device comprising:
dividing means for dividing a table in which cells are arranged in rows and columns into a plurality of sub-tables; and
extracting means for extracting a value corresponding to a key cell, that is, a cell expressing a key, from each of the plurality of sub-tables obtained by the division unit.
